(19) United States
(12) Patent Application Publication
(10) Pub. No.: US 2008/0204864 A1
(43) Pub. Date: Aug. 28, 2008

(54) Microscope Device With Position Sensing

(75) Inventor: Ulrich Sander, Rebstein (CH)

Correspondence Address: HODGSON RUSS LLP;THE GUARANTY BUILDING, 140 PEARL STREET, SUITE 100, BUFFALO, NY, 14202-4040, US

(73) Assignee: LEICA MICROSYSTEMS (SCHWEIZ) AG, Heerbrugg (CH)

(21) Appl. No.: 12/035,778

(22) Filed: Feb. 22, 2008

(30) Foreign Application Priority Data
Feb. 27, 2007 (DE) 10 2007 009 543.2

(51) Int. Cl. G02B 21/00

(52) U.S. Cl. 359/368

(57) ABSTRACT

The present invention relates to a microscope device (15) having a stand (5) carrying a microscope (1), and having at least one detector (21, 22, 23, 24, 26) for determining the three-dimensional position of the microscope, at least one acceleration sensor (24) being provided on the microscope (5). This permits a drastic reduction in the sensors required. In addition, reliable position sensing can be accomplished irrespective of soiling.

### CROSS REFERENCE TO RELATED APPLICATIONS

This application claims priority of German patent application no. 10 2007 009 543.2 filed Feb. 27, 2007, which is incorporated herein by reference.

### FIELD OF THE INVENTION

The present invention relates to a microscope device comprising a stand that carries a microscope, and at least one detector for the determination of the spatial position of the microscope.

### BACKGROUND OF THE INVENTION

In many microscope applications, especially also in microsurgery, a knowledge of the microscope's coordinates is important. In microsurgery, image data that have been obtained by a variety of imaging examination methods (such as computer tomography) are often projected, e.g. in the form of a sectional image, into the image of the specimen region under examination that is being viewed by the surgeon, in order to make the examination or the surgical procedure easier. It is extremely important in this context that the microscope, the specimen region on the patient being examined, and any further information that may be present (such as the aforesaid image data) are brought into the correct spatial relationship with one another.

A microscope device of the generic kind is known from DE 41 34 481 C2, in which a surgical microscope for computer-assisted stereotaxic microsurgery of a patient is suggested, said microscope comprising a multiple-joint stand for three-dimensional positioning and alignment of the surgical microscope, as well as multiple detectors for sensing the present three-dimensional or spatial location and alignment of the microscope. By means of a computer, image data are there correlated with the image of a specimen region being viewed. To ensure that the sectional image, derived from pre-operatively acquired image data that is overlaid is always the one relevant to the specimen region being viewed, the surgical microscope suggested therein comprises a measurement system that senses the distance between the surgical microscope and the specimen region being viewed. This requires a knowledge of the exact spatial coordinates and of the orientation of the surgical microscope. Suitable displacement and angle detectors in the multiple-joint stand serve for precise sensing of the position and orientation of the surgical microscope.

The measurement system proposed in DE 41 34 481 C2 further senses the distance between the specimen detail being viewed and the respective focal plane, and then determines, from the optical system data of the surgical microscope, the relative location of the specimen detail in front of the surgical microscope. The latter's spatial coordinates can be sensed by means of the aforementioned displacement and angle detectors in the multiple-joint stand. With respect to said detectors, the aforesaid document refers to DE 40 32 207 A1.

In this document (DE 40 32 207 A1) the aforesaid detectors are constructed from rotary encoders that are arranged in the respective rotary joints of the multiple-joint stand. Also present is a detector for sensing the displacement distance along the optical axis of the microscope. A computer unit calculates, on the basis of the detector signals, the displacement distance and the position of the microscope, and the position coordinates of a point observed within the specimen being examined, relative to a reference point inside the specimen. With the two-armed stand used therein that carries the microscope, a total of six detectors are necessary for this purpose.

The proposed angle detectors are, as a rule, pattern disks that are scanned by a suitable light source so that a displacement angle can be detected; or, in the case of motor-driven stands, angle sensors that can be similarly constructed or, on the basis of known motor properties, allow for concluding the displacement angle.

Motor-driven stands have the general disadvantage that they are not readily displaceable by hand since they comprise self-locking linkages or joints. If such stands are nevertheless actuated manually, it cannot be assumed that the angle detection system provides reliable data. The aforesaid angle detectors are moreover susceptible to soiling, and operate with an optical system that, by its very nature, is susceptible to error and wear. Lastly, also the number of detectors required represents a substantial disadvantage. Lust but not least, such solutions are technically complex and cost-intensive.

Also known is a position detection system for the microscope, in which said position detection is accomplished via the localization of markers. Either the markers can be mounted on the microscope itself and are located by a stationary localizing system, or the markers can be mounted at other spatial positions, for example in the specimen region, and can be located by a localizing system on the microscope itself. The use of such markers has the disadvantage that they can be covered by other pieces of equipment, persons, sterile cloths, or the like. Soiling of such markers also constitutes a problem.

A (surgical) microscope in which the observer (surgeon) does not need to look through the eyepieces of the microscope but instead has a substantially unrestricted view of the surgical field, a detail of which being simultaneously imaged in magnified fashion, is known from DE 10 2004 022 330 B3 (so-called clear-view microscope).

### SUMMARY OF THE INVENTION

The object of the present invention is, in the context of a generic microscope device, to simplify the determination of the three-dimensional position of the microscope.

This object is achieved, according to the present invention, by a microscope device as described herein. Advantageous embodiments are evident from the specification.

It is proposed according to the present invention that at least one acceleration sensor, in particular exactly one acceleration sensor, be present on the microscope as a detector for determination of the position of the microscope. As acceleration sensors are used, no mechanical or optical contact is required by the detector in order to determine the three-dimensional position of the microscope with respect to a reference point (pattern disk or initial position of an adjusting motor). The acceleration sensors, known per se, operate in wear-free fashion and are usable even in extreme situations such as in humid or dusty areas, but also in particular in microsurgery. In contrast to other known detectors for determining the three-dimensional position of a microscope, the proposed acceleration sensors have a small physical size, low power consumption and, finally, low manufacturing costs. In addition, determining the three-dimensional position of the microscope does not require a larger number of detectors that individually monitor each rotation and displacement point of a multi-member stand with regard to motion, and sense that motion; instead, in theory, a single acceleration sensor that is present on the microscope is already sufficient. What is meant by the feature “present on the microscope” is that at least one acceleration sensor is mounted directly on the microscope or in the microscope housing, or at any other point that is rigidly joined to the microscope (i.e. maintains its position relative to the microscope during a motion of the microscope).

By recording the motion of the microscope, it is also possible to reliably determine its current position. With regard to a motion direction, said determination is accomplished by a known double integration of the acceleration over time.

Two typical examples of acceleration sensors will be briefly outlined below. These are piezoresistive and capacitive acceleration sensors.

Piezoresistive acceleration sensors are based on the principle of measuring the displacement of a mass from its rest position as a result of an acceleration that occurs. For this purpose, an inert mass (silicon) is suspended by means of a thin flexural beam. When the sensor is accelerated, the mass, due to its inertia, deflects the beam out of its rest position. Piezoresistors mounted on the beam change their electrical resistance because of the resulting mechanical stresses. On the basis of this correlation, displacements in all three spatial directions can be measured by means of electrical signals. With regard to further details, reference is made to the known literature on piezoresistive acceleration sensors.

Capacitive acceleration sensors are based on the measurement principle that in a simple plate capacitor having a predetermined cross-sectional area, the capacitance changes as the spacing of the electrode plates changes. The corresponding acceleration sensor comprises a total of three electrode plates arranged parallel to one another, the outer electrode plates being fixedly installed while the center electrode plate is elastically mounted, so that said center electrode plate is displaced when an acceleration force acts on it. The capacitances generated by the three capacitors change accordingly. The voltage changes allow the acceleration to be deduced. Because this sensor type is also known per se, reference is made to the known literature with regard to further details.

An acceleration in all three spatial directions can be sensed (i.e. measured, detected, processed and determined) by means of the proposed acceleration sensors. It is also possible, however, to sense orientation, i.e. a rotation of the microscope about each of the three spatial axes. Whereas for certain applications a knowledge of only the three spatial coordinates is sufficient, for applications in microsurgery a knowledge of the angular coordinates of the microscope is usually also desired, which angular coordinates change as the microscope is rotated about any one of the spatial axes. The “position of the microscope” is therefore to be understood in the context of this application as the three spatial coordinates and, additionally, the three associated angular coordinates with respect to rotations about the three spatial axes. Optimally, therefore, all six degrees of freedom can be sensed by means of the acceleration sensor according to the present invention.

It may additionally be advantageous if one or more additional acceleration sensors are present not only on the microscope but also on the stand. This enables comparative measurements, plausibility considerations, and error minimization methods.

The microscope device according to the present invention is usable in particular for microscopes that are mounted on the stand and freely movable by hand.

The microscope device should encompass a control unit for receiving and processing those data that are sensed or supplied by the acceleration sensor or sensors.

In addition, a evaluation unit should be provided for displaying (i.e. reproducing, depicting, determining, or outputting) the three-dimensional position of the microscope. A evaluation unit of this kind is, in particular, connected downstream to the aforesaid control unit and calculates spatial coordinates and angle positions of the observed microscope from the data processed in the control unit. This evaluation unit can be a navigation system known per se.

It is necessary to indicate the position of the microscope with respect to a reference point, a fixed spatial point advantageously being selected for this. When a ceiling mount is used as the stand, this fixed spatial point is advantageously located in the suspension region of the ceiling mount, i.e. in the suspended column of the stand or in the transition from column to ceiling. Other suitable and known fixed spatial points are also possible as a reference point (zero point of the coordinate system). If possible, the reference point should not change even after an examination (operation) has been completed, or after movement of the specimen (patient) or specimen stage (patient table).

When a floor stand is used, it is advisable, before starting the examination or operation, to bring the stand into a fixed position that is not modified during the examination or operation. In this case in particular, it is useful to place the fixed spatial point in the region of the specimen to be examined. For operations on a patient's head, for example, the head is immobilized with a special stereotaxic frame that in turn can be fixedly joined to the operating table. A reference point on this stereotaxic frame can consequently serve as a reference point (zero point of the coordinate system).

When a floor stand is used, the location of the reference point usually changes after the examination or operation, since the position of both the specimen (patient) being examined and the floor stand usually changes. Another calibration must therefore be performed after the microscope is switched off and the microscope stand is moved, or after movement of the examination stage or operating table.

### BRIEF DESCRIPTION OF THE DRAWING VIEWS

The invention and its advantages will be further explained below with reference to an exemplifying embodiment that is illustrated in the attached drawings, in which:

FIG. 1 is a schematic side view of a microscope device according to the present invention, wherein a stand of the microscope device is a floor stand; and

FIG. 2 is a schematic side view of a microscope device according to the present invention, wherein a stand of the microscope device is a ceiling mount.

### DETAILED DESCRIPTION OF THE INVENTION

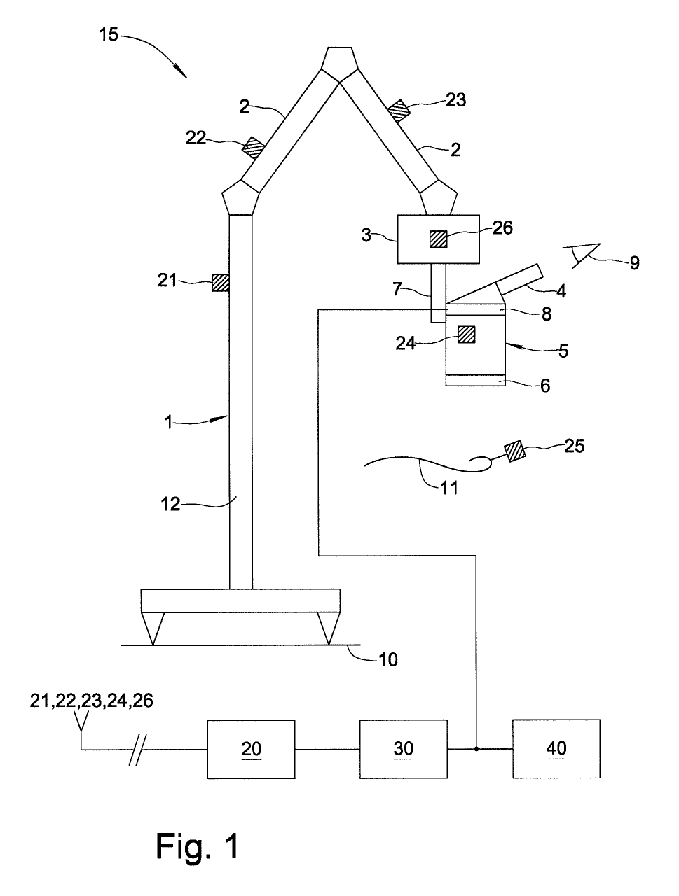

FIG. 1 is a schematic side view of a microscope device 15 having a surgical microscope 5 that is carried by a stand 1. Surgical microscope 5 is movable in all three spatial directions (in translation and in rotation). The exemplifying embodiment according to FIG. 1 refers to a floor stand 1 that stands on a floor 10. Stand 1 advantageously possesses magnetic brakes upon whose activation the set position is fixed. Upon deactivation, the respective joints are freely movable. Stand 1 as shown possesses freely movable joints, since self-locking linkages are not present. Stand 1 comprises, in addition to stand column 12 that is perpendicular to floor 10, a scissor arm 2 that is in turn made up of two arm parts joined to one another via a rotary joint. Scissor arm 2 is joined to stand column 12 via a further rotary joint. At its other end, scissor arm 2 is joined via a further rotary joint to a carrier arm 7 on which microscope 5 is mounted. Between carrier arm 7 and scissor arm 2 a X-Y displacement device 3 can be located by which carrier arm 7 and microscope 5 mounted thereon can additionally be moved in motorized fashion in a plane perpendicular to the drawing plane (in particular after activation of the magnetic brakes).

Microscope 5 mounted on carrier arm 7 encompasses, as known, a main objective 6 and a tube 4 having an eyepiece, these known components being depicted only very schematically. Microscope 5 is displaceable in translatory manner in all three spatial directions. In addition, it is mounted on carrier arm 7 in such a way that it is movable about all three spatial directions in rotational manner.

Reference sign 9 designates the schematically depicted observer's eye, e.g. the eye of a surgeon looking through the eyepiece of microscope 5. Microscope 5 provides a magnified image of a region on specimen (patient) 11. A reference point or, generally, a measurement point on said specimen 11 is labeled 25.

A data superimposing unit 8 is inserted in microscope 5 upstream the tube with eyepiece 4. By means of such a data superimposing unit 8, image data (e.g. computerized tomography sectional images), but also numerical data, graticules, and the like, can be superimposed onto the microscope image in a manner correlated with the particular microscope image. For example, a sectional CT diagnostic image can be superimposed in at the particular surgical location reproduced by the microscope image, and thus be overlaid on the microscope image so that diagnosis and surgery can be better coordinated. Other data overlays (numerical information e.g. about size ranges, crosshairs, graticules, indicating arrows, etc.) are also possible as a result.

In principle, a single acceleration sensor, labeled with the reference character 24, is sufficient for sensing any position of microscope 5. This includes, as already discussed, changes in terms of all six relevant degrees of freedom (three translational and three rotational degrees of freedom). Further acceleration sensors can be present for redundancy reasons (result confirmation, error minimization, plausibility considerations). Depicted for this purpose, by way of example, are sensors 21, 22, and 23, which are located on stand column 12 and on the two arms of scissor arm 2. In addition, an acceleration sensor 26 can be provided on X-Y displacement device 3.

The data of sensor 24 (and of any further sensors 21, 22, 23, and 26) are delivered to a control unit 20, where they are processed. The processed data are delivered to an evaluation unit 30 that is configured here as a navigation system. This navigation system 30 can have a downstream monitor or an external computer unit 40 for optical display or further data processing, respectively. For example, the coordinate system and the position of microscope 5 or of acceleration sensor 24 in relation to specimen 11 can be displayed optically on said monitor 40. It is additionally possible to present on said monitor 40 the same view seen by the observer or surgeon 9, i.e. in particular the microscope image with any superimposed data. The monitor and/or computer unit 40 are particularly advantageous for remote monitoring or remote viewing of the examination or the surgical procedure.

For superimposing of data, evaluation unit 30 controls a data superimposing unit 8 in the microscope 5. Depending on the specimen region being examined, previously stored data (e.g. sectional images or numerical data) matching the microscope image can be selected and superimposed onto said image. Data superimposing is known per se, so that reference can be made in this connection to known literature.

In this embodiment, a calibration of stand 1 secured to floor 10 is performed, for example, prior to an operation on a patient 11. For example, a specific point on the stereotaxic frame by which a patient's head is immobilized during the operation, serves as a reference point 25. This point 25 then represents, for example, the zero point of the coordinate system, so that all motions of microscope 5 are sensed and calculated with reference to said reference point 25. A recalibration must occur after the system is shut off (stand 1 is displaced) or after reference point 25 moves (movement of the operating table or stereotaxic frame). The downstream navigation system 30 also makes it possible to return reliably to specific positions that have been identified within a surgical cycle. In addition, sectional image data (already recited in the introduction to the description) can be superimposed onto the associated specimen images with high accuracy.

The use of acceleration sensors in microscope device 15 according to the present invention makes the coordinate sensing system of the microscope 5 extremely robust, independent of any soiling of the microscope 5 or of the acceleration sensor 24, and largely unsusceptible to errors, since the acceleration sensor 24 works entirely electronically. In addition, the sensors operate with little power consumption and can be obtained economically. The invention is, of course, also advantageously usable with the clear-view microscope recited above.

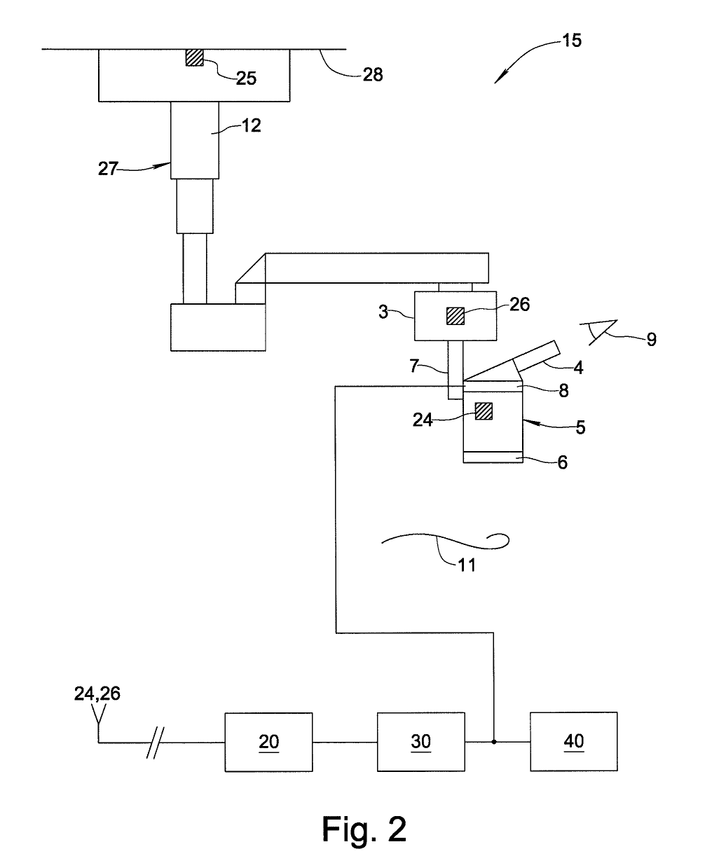

FIG. 2 is a schematic side view of microscope device 15 wherein floor stand 1 of FIG. 1 is replaced by a ceiling mount 27 as the stand. Ceiling mount 27 includes a column 12 mounted to a ceiling 28. When a ceiling mount is used as the stand, the fixed spatial point 25 is advantageously located in a suspension region of the ceiling mount, i.e. in the suspended column 12 of the stand or in the transition from column 12 to ceiling 28.

### PARTS LIST

1 Stand (floor stand)

2 Scissor arm

3 X-Y displacement device

4 Tube with eyepiece

5 Microscope

6 Main objective

7 Carrier arm

8 Data superimposing unit

9 Observer's eye

10 Floor

11 Specimen, patient

12 Stand column

15 Microscope device

20 Control unit

21, 22, 23, 24 Acceleration sensor

25 Measurement point, reference point

26 Acceleration sensor

27 Stand (ceiling mount)

28 Ceiling

30 Navigation system, evaluation unit

40 Monitor, external computer unit

What is claimed is:

1. A microscope device comprising:
a stand;
a microscope carried by the stand; and
at least one acceleration sensor mounted on the microscope for determining a three-dimensional position of the microscope.

2. The microscope device according to claim 1, wherein exactly one acceleration sensor is mounted on the microscope.

3. The microscope device according to claim 1, further comprising at least one other acceleration sensor mounted on the stand.

4. The microscope device according to claim 1, wherein the microscope is mounted on the stand and is freely movable by hand.

5. The microscope device according to claim 1, further comprising a control unit which receives and processes data sensed by the at least one acceleration sensor.

6. The microscope device according to claim 5, further comprising an evaluation unit which receives processed data from the control unit and determines a three-dimensional position of the microscope.

7. The microscope device according to claim 6, further comprising a display associated with the evaluation unit, wherein the three-dimensional position of the microscope is displayed by the display.

8. The microscope device according to claim 6, wherein the evaluation unit determines at least three position parameters.

9. The microscope device according to claim 8, wherein the evaluation unit determines six position parameters.

10. The microscope device according to claim 6, wherein the evaluation unit determines the position of the microscope with reference to a fixed spatial point.

11. The microscope device according to claim 6, wherein the evaluation unit determines the position of the microscope with reference to a fixed spatial point, and the position is displayed relative to the fixed spatial point.

12. The microscope device according to claim 10, wherein the stand is a ceiling mount and the fixed spatial point is located in a suspension region of the ceiling mount.

13. The microscope device according to claim 10, wherein the stand is a floor stand and the fixed spatial point is located in a region of a specimen to be examined using the microscope.

14. The microscope device according to claim 6, wherein the evaluation unit includes a navigation system.

15. The microscope device according to claim 6, further comprising a data superimposing unit connected to the evaluation unit, wherein the data superimposing unit displays correlated data into the microscope image.
